(19) United States
(12) Patent Application Publication
(10) Pub. No.: US 2005/0068784 A1
(43) Pub. Date: Mar. 31, 2005

(54) Lamp device for eliminating blind spot in automotive vehicle

(76) Inventor: Seung Sin Lee, Gyeongsangnam-Do (KR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/673,564

(22) Filed: Sep. 30, 2003

(51) Int. Cl. F21V 33/00

(52) U.S. Cl. 362/506

(57) ABSTRACT

A lamp device for eliminating a blind spot in an automotive vehicle. A lamp member is received, at a predetermined location, in a side panel of a vehicle body. A drive member pivots the lamp member by a predetermined angle. A control member has a lamp control part for controlling the lamp member and a drive control part for controlling the drive member. The lamp member includes an illumination lamp controlled by a signal generated in the lamp control part, and a reflection mirror mounted to be positioned behind the illumination lamp. A turn signal lamp is combined to one surface of the lamp member. The lamp control part is actuated in a manner interlocked with operation of the drive member. The drive control part includes a driving motor for pivoting the lamp member by the predetermined angle, and a motor control portion for controlling the driving motor.

### BACKGROUND OF THE INVENTION

1. Field of the Invention

The present invention relates, in general, to an automotive vehicle and, more particularly, to a lamp device for eliminating a blind spot in an automotive vehicle, which has an illumination lamp pivotally mounted to a side panel of the vehicle to offer a view to the rear to thereby widen a driver's field of view and contribute to elimination of one or more blind spots.

2. Description of the Prior Art

As well known to those skilled in the art, mirrors installed on an automotive vehicle, such as an inside rearview mirror and an outside rearview mirror provided inside and outside the vehicle body, respectively, serve as provisions for securing a driver's rear view vision. That is to say, the inside rearview mirror is provided in a cabin of the vehicle to allow a driver to check an immediate rear field of view, and the outside rearview mirror is provided out of the cabin of the vehicle to allow the driver to check a sideward rear field of view.

However, the conventional inside and outside rearview mirrors constructed as mentioned above are encountered with a problem in that, since there exist one or more blind spots which can not be viewed by a driver through the mirrors, such as a bottom portion of the vehicle and zones substantially positioned on the same planes as the mirrors, the probability of a safety issue to be roused is increased when parking or backing up the vehicle.

### SUMMARY OF THE INVENTION

Accordingly, the present invention has been made keeping in mind the above problems occurring in the prior art, and a primary object of the present invention is to provide a lamp device for eliminating a blind spot in an automotive vehicle, which has an illumination lamp pivotally mounted to a side panel of the vehicle to offer a view to the rear to thereby widen a driver's field of view and contribute to elimination of one or more blind spots that cannot be normally seen by the driver using ordinary rearview mirrors.

Another object of the present invention is to provide a lamp device for eliminating a blind spot in an automotive vehicle, wherein an illumination lamp capable of offering a view to the rear is combined with a turn signal lamp mounted to a front panel at a side of the vehicle so as to contribute to elimination of one or more blind spots.

In order to achieve the above object, according to one aspect of the present invention, there is provided a lamp device suitable for eliminating a blind spot in an automotive vehicle, comprising: a blind spot-eliminating lamp member received, at a predetermined location, in a side panel of a vehicle body; a drive member for pivoting the lamp member by a predetermined angle; and a control member having a lamp control part for controlling the lamp member and a drive control part for controlling the drive member.

According to another aspect of the present invention, the lamp member comprises an illumination lamp which is controlled by a signal generated in the lamp control part of the control member, and a reflection mirror which is mounted to be positioned behind the illumination lamp.

According to another aspect of the present invention, a turn signal lamp serving as a flasher is combined to one surface of the lamp member.

According to still another aspect of the present invention, the lamp control part is actuated in a manner interlocked with operation of the drive member.

According to yet still another aspect of the present invention, the drive control part comprises a driving motor for pivoting the lamp member by the predetermined angle, and a motor control portion for controlling the driving motor.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a partially enlarged schematic perspective view illustrating an automotive vehicle on which a lamp device for eliminating a dead spot in accordance with an embodiment of the present invention is installed;

FIG. 2 is a diagrammatic cross-sectional view illustrating a construction of the lamp device for eliminating a blind spot according to the present invention, shown in FIG. 1; and

FIG. 3 is a plan view illustrating an in-use state of the lamp device for eliminating a blind spot according to the present invention, shown in FIG. 1.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

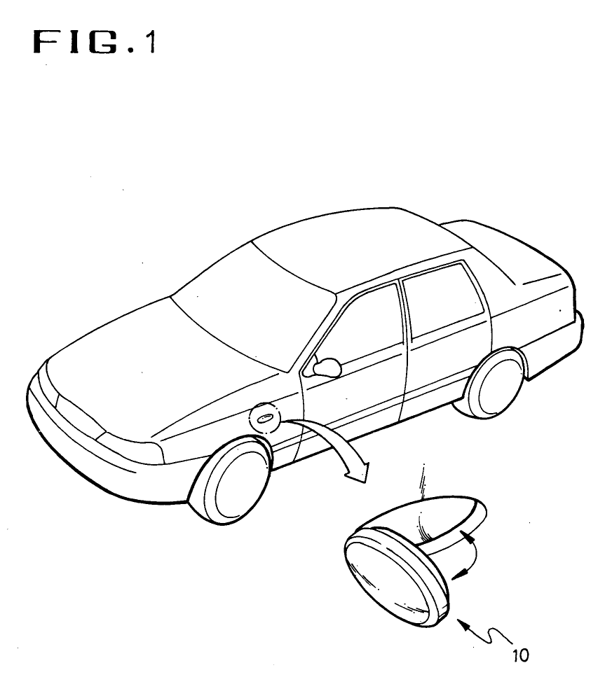

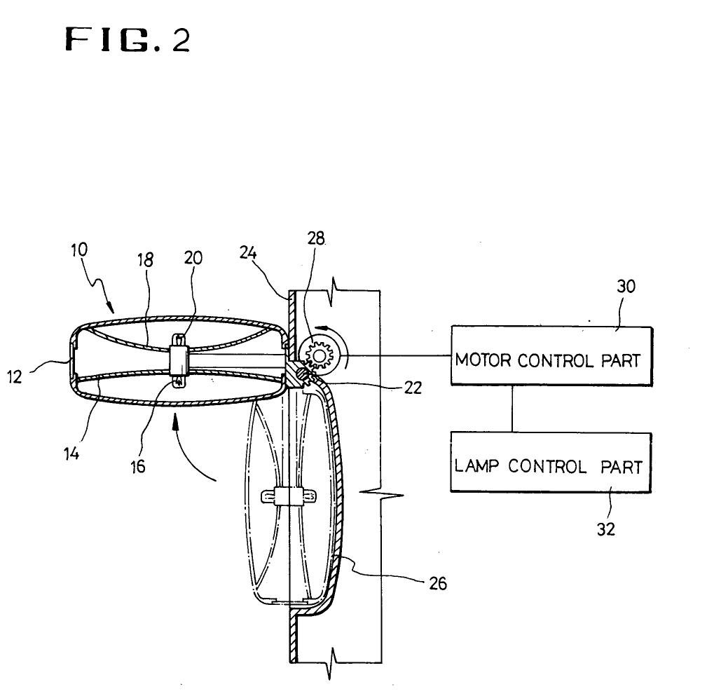

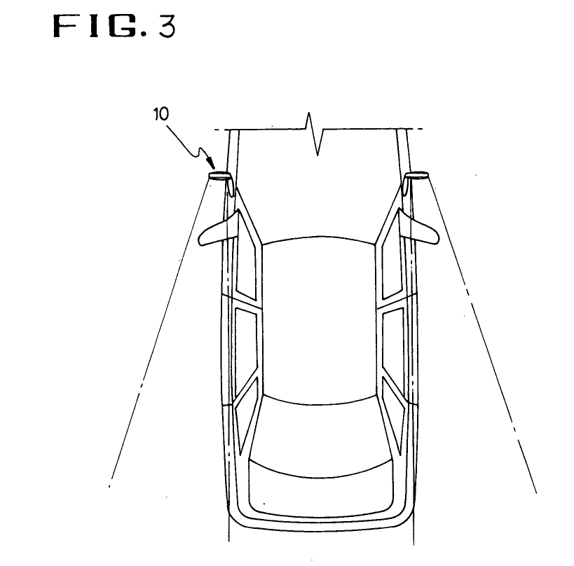

FIG. 1 is a partially enlarged schematic perspective view illustrating an automotive vehicle on which a lamp device for eliminating a dead spot in accordance with an embodiment of the present invention is installed; FIG. 2 is a diagrammatic cross-sectional view illustrating a construction of the lamp device for eliminating a blind spot according to the present invention, shown in FIG. 1; and FIG. 3 is a plan view illustrating an in-use state of the lamp device for eliminating a blind spot according to the present invention, shown in FIG. 1.

As shown in the drawings, a lamp device for eliminating a dead spot in accordance with an embodiment of the present invention comprises a turn signal lamp 10, a drive motor 28 and control parts 30 and 32. While the lamp device applied to a vehicle having a turn signal lamp 10 is illustrated in this preferred embodiment of the present invention, a person skilled in the art will readily recognize that the lamp device according to the present invention can be applied to various kinds of automotive vehicles.

The turn signal lamp 10 is received in a front quarter panel 24 which constitutes a body of the vehicle, and has a flasher and an illumination lamp. Concretely speaking, the turn signal lamp 10 includes a casing 12 which serves as a housing and defines an accommodating space, a flasher 20 which is supported by a support plate 18 and accommodated in the accommodating space of the casing 12 to flicker when the casing 12 is received in a receiving cavity 26 defined in the quarter panel 24, and an illumination lamp 16 which is pivotally mounted in the receiving cavity 26 of the casing 12 to emit lights in a direction opposite to the flasher 20.

A reflection mirror 14 is mounted behind the illumination lamp 16 so that an illumination intensity of the lights emitted from the illumination lamp 16 can be increased.

It is to be noted that not only the turn signal lamp 10 may be mounted to a door outside panel or a rear quarter panel of the vehicle, but also the illumination lamp 16 may be separated from the turn signal lamp 10 to be independently mounted to an outside rear view mirror.

The drive motor 28 is connected to one widthwise end of the turn signal lamp 10 to pivot the turn signal lamp 10 by a predetermined angle as occasion demands. The drive motor 28 has a first gear which is meshed with a second gear secured around a hinge shaft 32 provided to the one widthwise end of the turn signal lamp 10. The pivoting angle of the turn signal lamp 10 is controlled by the motor control part 30.

The lamp control part 32 for controlling the flasher 20 and the illumination lamp 16 of the turn signal lamp 10 may be configured to control the flasher 20 and the illumination lamp 16 in a separated manner.

Hereafter, operations of the lamp device according to the present invention, constructed as mentioned above, will be described.

When it is necessary to view a blind spot, if a driver manipulates a push button (not shown) arranged around the driver's seat, the motor control part 30 is operated, and the casing 12 of the turn signal lamp 10 is pivoted out of the receiving cavity 26 of the front quarter panel 24 toward a projecting position.

Thereafter, as the driver further manipulates the lamp control part 32, as shown in FIG. 3, the illumination lamp 16 begins to emit lights to offer a view to the blind spot, by which the driver can easily check the blind spot.

While the vehicle normally travels on the road, since the turn signal lamp 16 is held received in the receiving cavity 26 of the quarter panel 24, it is not necessary to manipulate the turn signal lamp 10, and the flasher 20 of the turn signal lamp 10 can be flickered on and off simply by manipulating a combination switch arranged around the driver's seat.

As apparent from the above description, the lamp device according to the present invention, constructed as mentioned above, provides advantages in that, since an illumination lamp capable of being pivoted and offering a view to the rear is combined with a turn signal lamp mounted to a side panel of the vehicle, a driver's field of view is widened and it is possible to contribute to elimination of one or more blind spots that cannot be normally seen by the driver using ordinary rearview mirrors, whereby safe driving of the vehicle can be ensured.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A lamp device suitable for eliminating a blind spot in an automotive vehicle, comprising:
a blind spot-eliminating lamp member received, at a predetermined location, in a side panel of a vehicle body;
a drive member for pivoting the lamp member by a predetermined angle; and
a control member having a lamp control part for controlling the lamp member and a drive control part for controlling the drive member.

2. The lamp device as set forth in claim 1, wherein the lamp member comprises an illumination lamp which is controlled by a signal generated in the lamp control part of the control member, and a reflection mirror which is mounted to be positioned behind the illumination lamp.

3. The lamp device as set forth in claim 2, wherein a turn signal lamp serving as a flasher is combined to one surface of the lamp member.

4. The lamp device as set forth in claim 1, wherein the lamp control part is actuated in a manner interlocked with operation of the drive member.

5. The lamp device as set forth in claim 1, wherein the drive control part comprises a driving motor for pivoting the lamp member by the predetermined angle, and a motor control portion for controlling the driving motor.
